(19) United States
(12) Patent Application Publication
(10) Pub. No.: US 2009/0032335 A1
(43) Pub. Date: Feb. 5, 2009

(54) Bearing-Lubricating Structure for a Direct Drive Torque Motor

(76) Inventors: Fu-Yuan CHENG, Taichung (TW); Chih-Hsien Chao, Taichung (TW)

Correspondence Address: Dr. BANGER SHIA, 102 Lindencrest Ct., Sugar Land, TX, 77479-5201, US

(21) Appl. No.: 11/833,924

(22) Filed: Aug. 3, 2007

(51) Int. Cl. F16C 19/00

(52) U.S. Cl. 184/5.1

(57) ABSTRACT

A bearing-lubricating structure for a direct drive torque motor comprises a body, a direct drive torque motor, a main shaft, a bearing assembly, an adjustment nut and an oil-filling assembly. The bearing assembly includes an assistant roller bearing which is positioned against the rear cover, the main shaft and the adjustment nut. The rear cover is defined with a lubrication oil piping, which is communicated to the assistant roller bearing and communicated to an annular lubrication space located between the rear cover and the adjustment nut. The oil-filing assembly is mounted on an open end of the lubrication oil piping. Thereby, with the abovementioned simplified structure, the main shaft can be lubricated, and the maintenance cost can be reduced.

### BACKGROUND OF THE INVENTION

1. Field of the Invention

The present invention relates to a lubrication structure for a direct drive torque motor, and more particularly to a bearing-lubricating structure for a direct drive torque motor which can utilize a simplified structure to lubricate the bearing and reduce the maintenance cost.

2. Description of the Prior Art

The motors are used more and more widely in modem industries, and there are categories of external rotor, internal rotor and so on. In addition to the high precision in the feeding transmission, the motor also has the advantages of low friction loss, high energy conversion efficiency and low noise, etc. Hence, the motor is obviously important to the modem industrial tool machines.

The existing direct drive torque motors are applied to the drive of the axis equipments, such as the automatic equipment, the indexing plate and each type of tool machine. No matter how the configurations of various products are designed, between the direct drive torque motor and the main shaft are generally disposed many bearing structures, so that the smoothness of the rotating motion relative to each other can be maintained. Though the abovementioned design has been put into service, it still has many problems to be solved.

After the direct drive torque motor and the main shaft have operated for a certain time, the bearing structures for loading the direct drive torque motor and main shaft must be maintained and lubricated regularly by the operator. However, as for the bearings located inside the mechanism, they can be maintained after the whole mechanism is disassembled, thus increasing the maintenance cost.

In order to solve the abovementioned relevant problems, based on the accumulative research technology and experience in the field of the motor, from the angle of simplifying the design and adequately lubricating, the applicant of the present invention has developed a bearing-lubricating structure for a direct drive torque motor.

### SUMMARY OF THE INVENTION

The primary objective of the present invention is to provide a bearing-lubricating structure for a direct drive torque motor which can utilize a simplified structure to lubricate the main shaft and reduce the maintenance cost.

In order to achieve the abovementioned objective, the present invention utilizes the main shaft cooperating with the adjustment nut to fix the torque motor, the bearing assembly and the body. The bearing assembly includes an assistant roller bearing which is positioned against the rear cover, the main shaft and the adjustment nut. The rear cover is defined with a lubrication oil piping, which is communicated to the assistant roller bearing and communicated to an annular lubrication space located between the rear cover and the adjustment nut. The oil-filing assembly is disposed on an open end of the lubrication oil piping. Thereby, with the abovementioned simplified structure, the main shaft can be lubricated, and the maintenance cost can be reduced.

It is to be noted that, the assistant roller bearing is a tapered roller bearing, two adjacent sides of which are positioned between the rear cover, the main shaft and the adjustment nut, and the lubrication oil piping is communicated to two adjacent load sides of the assistant roller bearing, respectively.

One end of the lubrication can be defined with an exhaust hole opened outwards, and the exhaust hole can be U-shaped to prevent the water from penetrating in, and it can also be used for observing from external if the oil overflows the exhaust hole, thus observing the oil-filling state.

In addition, a brake assembly can be disposed between the body and the main shaft, and a cooling assembly is located in the body to cool the direct drive torque motor. Additionally, a position-sensing assembly is installed on the body to sense the rotating position of the main shaft.

The abovementioned brake assembly can be a pressure cylinder between the body and the main shaft. The pressure is injected into the pressure cylinder to press the main shaft to achieve the brake effect. Such a brake technology is within the scope of the present invention.

The assistant roller bearing is positioned against the rear cover of the body, the main shaft and the adjustment nut, so the present invention aims at lubricating the assistant roller bearing which bears the maximum load. As for other bearings disposed between the body and the main shaft, the quantity and the positions of the bearing seats, they are not features of the present invention.

### BRIEF DESCRIPTION OF THE DRAWINGS

FIG. 1 is a perspective view of a bearing-lubricating structure for a direct drive torque motor in accordance with the present invention;

FIG. 2 is a cross sectional view of the bearing-lubricating structure for a direct drive torque motor in accordance with the present invention; and

FIG. 3 is an enlarged cross sectional view of the bearing-lubricating structure for a direct drive torque motor in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

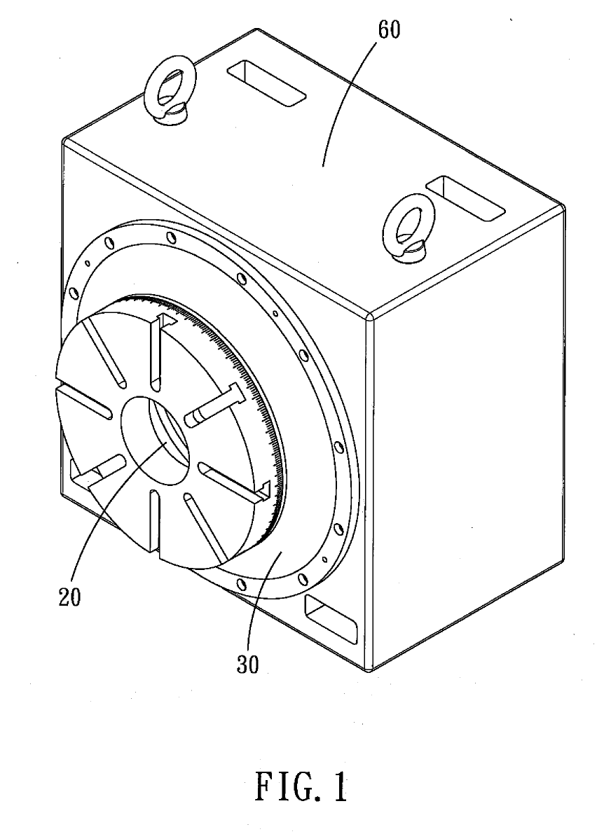

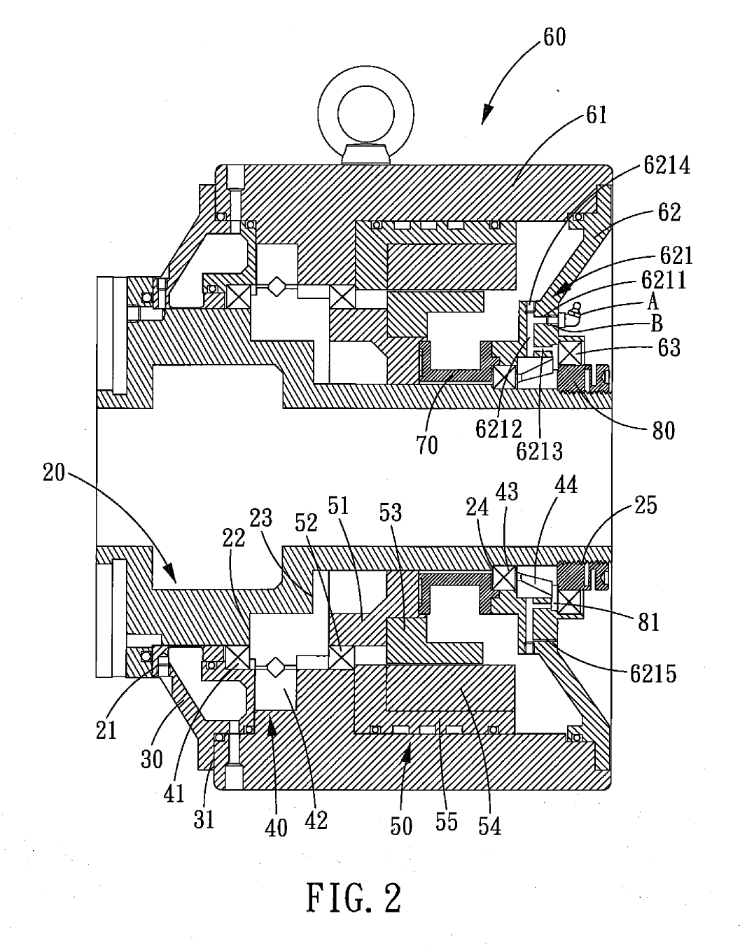

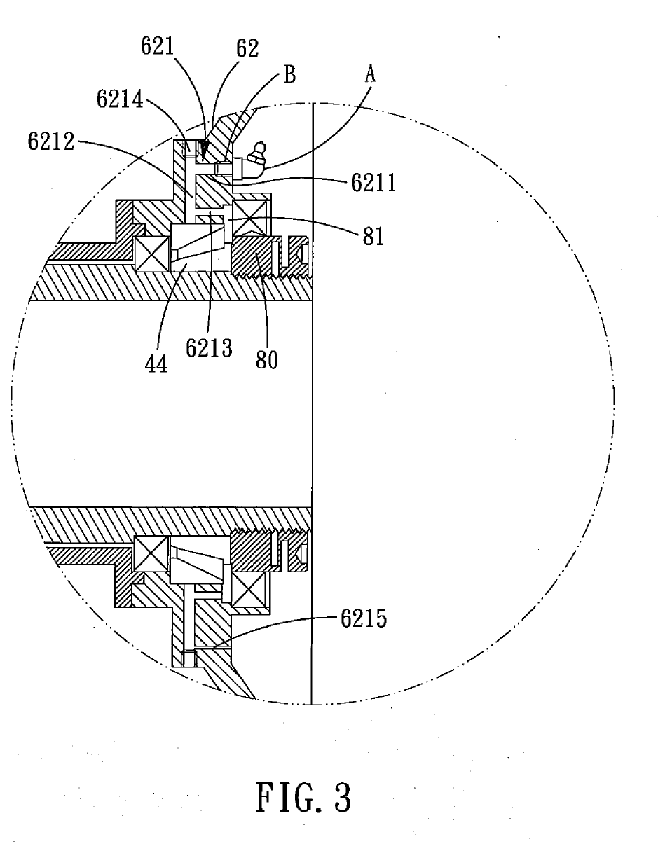

Referring to FIGS. 1-3, a bearing-lubricating structure for a direct drive torque motor in accordance with a preferred embodiment of the present invention comprises a main shaft 20, a brake assembly 30, a bearing assembly 40, a direct drive torque motor 50, a body 60, an oil-filling assembly A, a position-sensing assembly 70 and an adjustment nut 80.

The outer surface of the main shaft 20 includes a first stage 21, a second stage 22, a third stage 23, a fourth stage 24 and an external thread segment 25 that are successively tapered from one end to the other end of the main shaft 20. The external thread segment 25 is formed at one end of the main shaft 20.

The inner side of the brake assembly 30 is positioned against the first stage 21 of the main shaft 20, and the outer side of the brake assembly 30 includes a positioning portion 31.

The bearing assembly 40 includes a first oil seal 41, a main bearing 42, a second oil seal 43 and an assistant roller bearing 44. The first oil seal 41 is disposed between the brake assembly 30 and the main shaft 20. The main bearing 42 is located on the second stage 22 of the main shaft 20 and positioned against the brake assembly 30. The second oil seal 43 is located on the third stage 23 of the main shaft 20. The assistant roller bearing 44 is in the form of a tapered roller, located on the fourth stage 24 together with second oil seal 43 and positioned against the second oil seal 43.

The direct drive torque motor 50 includes a mover-fixing seat 51, a mover oil seal 52, a mover 53, a stator 54 and a motor-cooling seat 55. The mover-fixing seat 51 is positioned against one side of the main bearing 42 of the bearing assembly 40. The mover oil seal 52 and the mover 53 are fixed outside the mover-fixing seat 51. The stator 54 is fixed in the motor-cooling seat 55 and the stator 54 is mounted on the mover 53.

The body 60 includes a shell member 61, a rear cover 62 and a rear cover oil seal 63. The shell member 61 is fixed with the rear cover 62. One end of the body 60 is fixed with the positioning portion 31 of the brake assembly 30. The body 60 and the main shaft 20 are positioned by the main bearing 42 of the bearing assembly 40, and the rear cover 62 is located outside the second oil seal 43 and the assistant roller bearing 44 of the bearing assembly 40. The rear cover oil seal 63 is disposed on the inner side of the bottom of the rear cover 62. The shell member 61 is located outside for an accommodation of all abovementioned assemblies and used for fixing the motor-cooling seat 55 of the direct drive torque motor 50. In the rear cover 62 is defined at least one lubrication oil piping 621, and the lubrication oil piping 621 includes an oil-filling passage 6211, a first lubrication passage 6212, a second lubrication passage 623 and a sealing screw element 6241. The sealing screw element 6241 is used to seal the open hole formed during the manufacturing operation (detailed description is omitted here). The oil-filling passage 6211, the first lubrication passage 6212 and the second lubrication passage 6213 are communicated with each other, and the oil-filling passage 6211 is opened outwards from the rear cover 62 and formed with an internal thread B. The first lubrication passage 6212 is communicated to the surface of one side of the assistant roller bearing 44 of the bearing assembly 40, and the second lubrication passage 6213 is communicated to the surface of the other side of the assistant roller bearing 44 of the bearing assembly 40. One end of the lubrication oil piping 621 is formed with an exhaust hole 6215 which opens outwards and is U-shaped for preventing the water from penetrating in.

The oil-filling assembly A is screwed in the internal thread B of the oil-filling passage 6211 of the body 60.

The position-sensing assembly 70 is fixed on the rear cover 62 of the body 60 to sense the rotating position of the main shaft 20.

The adjustment nut 80 is screwed on the external thread segment 25 of the main shaft 20 and located in the rear cover oil seal 63 of the body 60. Moreover, the adjustment nut 80 is adjusted to press against the assistant roller bearing 44 of the bearing assembly 40. The surface of the adjustment nut 80 facing the assistant roller bearing 44 is defined with a concave annular lubrication space 81 which is communicated with the second lubrication passage 6213 of the body 60.

The aforementioned is the summary of the positional and structural relationship of the respective components of the preferred embodiment in accordance with the present invention.

For a better understanding of the present invention, its operation and function are described as follows:

The outer surface of the main shaft 20 includes a first stage 21, a second stage 22, a third stage 23, a fourth stage 24 and an external thread segment 25 that are successively tapered from one end to the other end of the main shaft 20. The external thread segment 25 is formed at the end of the main shaft 20. By cooperating with the bearing assembly 40, the main shaft 20 fixes the brake assembly 30, the direct drive torque motor 50, and the body 60 on the respective stages from one side thereof. Thereafter, the adjustment nut 80 is screwed on the external thread segment 25 of the main shaft 20 and then adjusted to press against the assistant roller bearing 44 of the bearing assembly 40.

Hence, when the adjustment nut 80 presses against the assistant roller bearing 44, the assistant roller bearing 44 which is a tapered roller bearing synchronously pushes the rear cover 62 of the body 60 and adequately bears the assemblies located on the main shaft 20.

Since the lubrication oil piping 621 of the rear cover 62 utilizes the first lubrication passage 6212 and the second lubrication passage 6213 to adequately lubricate the surface of the assistant roller bearing 44 and the annular lubrication space 81. By cooperating with the flow of the oil in the annular lubrication space 81, the present invention can substantially offer the lubricating function.

When the oil is to be injected, the operator only needs to inject the oil into the oil-filling assembly A. Thereafter, the oil will flow into the first lubrication passage 6212 and the second lubrication passage 6213 through the oil-filling passage 6211 of the body 60. During the oil-injecting operation, the exhaust hole 6215 of the lubrication oil piping 621 is used to observe if the oil is enough. If the oil overflows the exhaust hole 6215, it represents that the oil is full enough.

In addition, the abovementioned concave annular lubrication space 81 can be defined in both the surface of the assistant roller bearing 44 and the surface of the adjustment nut 80.

To summarize, the bearing-lubricating structure for a direct drive torque motor of the present invention comprises a body, a direct drive motor, a main shaft, a bearing assembly, an adjustment nut and an oil-filling assembly. The assistant roller bearing is positioned against the rear cover, the main shaft and the adjustment nut. The rear cover is defined with a lubrication oil piping, which is communicated to the assistant roller bearing and communicated to an annular lubrication space located between the rear cover and the adjustment nut. The oil-filing assembly is disposed on an open end of the lubrication oil piping. Thereby, with the abovementioned simplified structure, the main shaft can be lubricated, and the maintenance cost can be reduced.

While we have shown and described various embodiments in accordance with the present invention, it is clear to those skilled in the art that further embodiments may be made without departing from the scope of the present invention.

What is claimed is:

1. A bearing-lubricating structure for a direct drive torque motor comprising:
a body including a rear cover in which at least one lubrication oil piping being arranged, the lubrication oil piping including an oil-filling passage, a first lubrication passage and a second lubrication passage that are communicated with each other, and the oil-filling passage being opened outwards;
a direct drive torque motor disposed in the body;
a main shaft disposed in the direct drive motor;
a bearing assembly being disposed between the main shaft, the direct drive torque motor and the body and including an assistant roller bearing positioned against the rear cover of the body and the main shaft, the first lubrication passage of the lubrication oil piping of the body being communicated to a surface of one side of the assistant roller bearing, and the second lubrication passage of the body being communicated to a surface of the other side of the assistant roller bearing;
an oil-filling assembly being mounted on the oil-filling passage of the body; and
an adjustment nut being screwed on an external thread segment located on one end of the main shaft and adjusted to press against the assistant roller bearing of the bearing assembly, the adjustment nut including an annular lubrication space located correspondingly to the assistant roller bearing, and the second lubrication passage of the body being communicated to the annular lubrication space.

2. The bearing-lubricating structure for a direct drive torque motor as claimed in claim 1, wherein the assistant roller bearing is a tapered roller bearing.

3. The bearing-lubricating structure for a direct drive torque motor as claimed in claim 1 further comprising a brake assembly and a position-sensing assembly, wherein:
an outer surface of the main shaft is formed with a first stage, a second stage, a third stage, a fourth stage and an outer thread segment that are successively tapered;
an inner side of the brake assembly is located on the first stage of the main shaft, and an outer side of the brake assembly includes a positioning portion;
the bearing assembly further includes a first oil seal, a main bearing, a second oil seal, the first oil seal is installed between the brake assembly and the main shaft, the main bearing is located on the second stage of the main shaft and positioned against the brake assembly, the second oil seal is located on the third stage of the main shaft, the assistant roller bearing is located on the fourth stage of the main shaft and positioned against the second oil seal;
the direct drive torque motor includes a mover-fixing seat, a mover oil seal, a mover, a stator and a motor-cooling seat, the mover-fixing seat is positioned against one side of the main bearing of the bearing assembly, the mover oil seal and the mover are fixed outside the mover-fixing seat, the stator is installed in the motor-cooling seat and mounted on the mover;
the body further includes a shell member and a rear cover oil seal, the shell member and the rear cover are fixed with each other, one end of the body is fixed with the positioning portion of the brake assembly, the body and the main shaft are positioned by the bearing assembly, the rear cover of the body is located outside the second oil seal and the assistant roller bearing of the bearing assembly, an inner inside of a bottom of the rear cover is disposed with the rear cover oil seal, the shell member is located outside for an accommodation of all the abovementioned assemblies and used for fixing the motor-cooling seat of the direct drive torque motor;
the position-sensing assembly is fixed on the rear cover of the body to sense rotating position of the main shaft.

4. The bearing-lubricating structure for a direct drive torque motor as claimed in claim 1, wherein the lubrication oil piping is formed with a plurality of open holes for facilitating fabrication, and a sealing screw element is disposed in the open hole to seal the open hole.

5. The bearing-lubricating structure for a direct drive torque motor as claimed in claim 1, wherein one end of the lubrication oil piping of the body is formed with an exhaust hole opening outwards.

6. The bearing-lubricating structure for a direct drive torque motor as claimed in claim 5, wherein the exhaust hole is a U-shaped structure for preventing water from penetrating in.

7. The bearing-lubricating structure for a direct drive torque motor as claimed in claim 1, the annular lubrication space of the adjustment nut is a concave structure formed in a surface of the adjustment nut.

8. The bearing-lubricating structure for a direct drive torque motor as claimed in claim 1, the annular lubrication space of the adjustment nut is a concave structure formed both in a surface of the adjustment nut and a surface of the assistant roller bearing.
